(19) United States
(12) Patent Application Publication
(10) Pub. No.: US 2024/0183079 A1
(43) Pub. Date: Jun. 6, 2024

(54) PROCESS TO MANUFACTURE AN ARAMID SOLUTION

(71) Applicant: TEIJIN ARAMID B.V., ARNHEM (NL)

(72) Inventors: Bert GEBBEN, Velp (NL); Monique MEEUSEN-WIERTS, Elst (NL)

(73) Assignee: TEIJIN ARAMID B.V., Arnhem (NL)

(21) Appl. No.: 18/286,494

(22) PCT Filed: Apr. 12, 2022
(86) PCT No.: PCT/EP2022/059732

§ 371 Date: Oct. 11, 2023

(30) Foreign Application Priority Data
Apr. 15, 2021 (EP) 21168636.5

(51) Int. Cl. D01D 1/02; D01D 1/06; D01F 6/60

(52) U.S. Cl. CPC D01D 1/02; D01D 1/06; D01F 6/60

(57) ABSTRACT

A process to manufacture a solution of aramid includes: i) combining a solvent and a base to result in a solvent-base mixture, ii) adding aramid material to the solvent-base mixture to obtain a composition, and iii) mixing the composition to obtain a solution of aramid, wherein at least 1 Mol of base per liter of solvent is added to obtain the solvent-base mixture. An aramid solution, processes to further process the solution, and a continuous aramid fiber with high elongation.

Instant invention pertains to a process to manufacture a solution of aramid, to a solution comprising aramid and to processes to further process the solution into a continuous aramid fiber, an aramid nanofiber or an aramid film, and also to a continuous aramid fiber and to a material comprising the aramid nanofiber.

EP0309229A2 describes the preparation of articles from isotropic and anisotropic solutions of aromatic polyamide anion salts (e.g. the potassium or sodium salt) in liquid sulfoxides, such as DMSO. The solutions may be processed into fibers, films and coatings. The aramid solutions are generally prepared with a solids content of about 1.5 to 1.7 wt %. Solutions with a higher polymer content, up to 12 wt %, can be obtained for example by evaporating the solvent in vacuum or freeze drying.

EP1631707A1 describes a non-fibrous aramid solution of para-aramid with high relative viscosity. The solution comprises a polar amide solvent, alkali chloride or earth alkali chloride, water and 1-8 wt % of aramid. The solution shows anisotropic behavior and may be processed by jet spinning to obtain pulp-like fiber.

US2013/0288050 describes how macroscale aramid fibers may be dissociated to aramid nanofibers (ANF). To obtain the aramid nanofibers, macroscale aramid fibers are combined with a solution containing a base (KOH) and an aprotic solvent (DMSO) and stirred. Minor amounts of the macroscale aramid fibers are present in the suspension. The process of forming a suspension of aramid nanofibers takes very long (several days).

WO2017/117376 discloses how branched ANFs can be made by adjusting the reaction media containing aprotic component, protic component and a base. Relative to the amount of solvent, the concentration of aramid and base is low. Reaction times are generally in the order of days or weeks.

CN110055797 describes a method for preparing aramid nanofibers, wherein a para-aramid fiber and KOH are added to DMSO, the mixture is subjected to sonication, water is added and this suspension is sealed and stirred to obtain aramid nanofibers. This process allows to add a higher amount of para-aramid fiber (up to 4 wt %) and has a shorter reaction time (e.g. 12 hours).

CN103937237A discloses a preparation method of a para-aramid nanofiber solution having an aramid concentration of 0.05 to 3.6 wt % wherein the para-aramid nanofiber has a diameter of 20 to 50 nm and a length of 2 μm to 10. In the process the amount of deprotonating reagent mixed with the DMSO is 0.42 to 33.5 mmol and the dissolution process takes between 6 and 72 hours, in the examples for low aramid concentrations dissolution times of at least 36 or 48 hours are required and for an aramid concentration of 3.6 wt % a dissolution time of 72 hours is required.

It is desirable to prepare a solution with an even higher aramid concentration, in particular to obtain an anisotropic solution of aramid from aramid material which may be processed into different materials, including aramid nanofiber and aramid continuous fiber. In particular, it is of interest to obtain such solution with a high aramid content in short time. Preferably, such a process does not require to first prepare a dilute aramid solution to dissolve the aramid and subsequently concentrate such solution.

This is possible with the instantly claimed process to manufacture a solution of aramid comprising:
i) combining a solvent and a base to result in a solvent-base mixture,
ii) combining aramid material with the solvent-base mixture to obtain a composition, and
iii) mixing the composition to obtain a solution of aramid,
   wherein at least 1 Mol of base per liter of solvent is added to obtain the solvent-base mixture.

The aramid material may include aramid fiber (including but not limited to continuous aramid fiber, non-continuous aramid fiber), aramid pulp, aramid film, aramid paper, aramid fibrids, aramid polymer particles (e.g. powder or crumbs) and any combination thereof. The aramid material may include aramid obtained from recycling, thus based on end-of-life materials or production waste. Preferably, the aramid material used as starting material comprises non-continuous aramid fiber. The non-continuous aramid fiber preferably have a length (or largest dimension) in the range of 0.1 mm to at most 100 cm, preferably at most 50 cm, more preferably at most 20 cm, even more preferably at most 10 cm, or up to 5 cm.

Fibers are to be understood as relatively flexible units of matter having a high ratio of length to width (across their cross-sectional area, perpendicular to their length).

In the context of this application the term “length” refers to the length weighted length (LL) for short fibers and the mean length for longer fibers. For short fibers (and pulp, fibrils and fibrids) up to a length of 6 mm the length weighted length may be determined by using the Pulp Expert™ FS (ex Metso), including particles with a length<250 micron. For larger fibers (>6 mm) the length refers to the average fiber length by number (mean length, ML), which may be calculated by:

$$ML = \frac{{\sum }_{0}^{∞} n \cdot {L}_{n}}{N}$$

where n is the number of fibers of a certain length Lₙ, and N is the total number of fibers. The mean length may be determined with a fiber length distribution tester, such as a Classifiber (ex Kaisokki).

The aramid fibers may be in the form of short-cut.

Short-cut comprises short filaments and may e.g. be obtained by cutting continuous yarn, fabrics or woven materials.

The aramid material may comprise pulp. Pulp consists of short fibers which have been subjected to a shearing force leading to the formation of fibrils, which are mostly connected to a “stem” of the original fiber, while thinner fibrils peel off from the thicker fibrils. These fibrils are curly and sometimes ribbon-like, and show variations in length and thickness.

In one embodiment the aramid short-cut fiber has a length in the range of 0.1 to 20 mm, preferably 1 to 10 mm, more preferably 3 to 8 mm.

Preferably, the aramid short-cut has a narrow length distribution.

In one embodiment, the length distribution of the aramid short-cut is such that at least 50 weight % of the filaments have a length which is within 30% of the length at a peak maximum in the length distribution curve. Preferably, at least 70 weight % of the filaments have a length which is within 30% of the length at a peak maximum in the length distribution curve.

In the context of the present specification aramid refers to an aromatic polyamide consisting of aromatic moieties directly connected to one another via amide fragments. Methods to synthesize aramids are known to those skilled in the art and typically involve the polycondensation of aromatic diamines with aromatic diacid halides. Aramids may exist in the meta- and para-form. Preferably, the aramid material is para-aramid material.

For the purpose of this application, the term para-aramid refers to a class of wholly aromatic polyamide polymers and copolymers having at least 60%, preferably at least 80% and more preferably at least 90% of para-oriented bonds between the aromatic moieties. In one embodiment, at least 95% or all (i.e. 100%) of the bonds are para-oriented bonds. Examples of the para-oriented aromatic diamine usable in the present invention include para-phenylenediamine, 4,4′-diaminobiphenyl, 2,6-naphthalenediamine, 1,5-naphthalene-diamine, and 4,4′-diaminobenzanilide. To a maximum of 50 mole % substituted aromatic diamines can be used, such as 2-methyl-para-phenylenediamine and 2-chloro-para-phenylenediamine. Examples of para-oriented aromatic dicarboxylic acid halide usable in the present invention include terephthaloyl dichloride, 4,4′-benzoyl dichloride, 2,6-naphthalene-dicarboxylic acid dichloride, and 1,5-naphthalenedicarboxylic acid dichloride.

Typical para-aramids are poly(para-phenylene terephthalamide) (PPTA), poly(4,4′-benzanilide terephthalamide), poly(para-phenylene-4,4′-biphenylene dicarboxamide) and poly(para-phenylene-2,6-naphthalene dicarboxamide), 5,4′-diamino-2-phenylbenzimidazole or poly(para-phenylene-co-3,4′-oxidiphenylene terephthalamide) or copolymers thereof. Preferably, the aramid material comprises or consists of poly(para-phenylene terephthalamide).

The solvent is an aprotic solvent, preferably a polar aprotic solvent.

In one embodiment the solvent is selected from dimethyl sulfoxide (DMSO), dimethyl formamide (DMF), dichloro methane (DCM), dimethyl acetamide (DMAc or DMA), tetramethyl urea or N-Methyl-2-pyrrolidone (NMP), or mixtures thereof. Preferably, the solvent is DMSO.

The solvent is not sulfuric acid. Preferably, the solvent is free of alkali salts and earth alkali salts, in particular chlorides.

The base is preferably a strong base, preferably a base with a dissociation constant pKa (in water) of at least 10, more preferably a base with a dissociation constant pKa of at least 11. Such bases include for example oxides of alkali metals.

In one embodiment, potassium hydroxide (KOH), sodium hydroxide (NaOH), potassium ethoxide (EtOK), sodium hydride (NaH), potassium tert-butoxide (tBuOK), potassium hydride (KH) or sodium amide (NaNH₂) is used as base.

In one embodiment, DMSO as solvent and KOH as base are used.

In one embodiment of the process, at least 1.5 Mol base per liter of solvent, or preferably at least 2 Mol base per liter of solvent, more preferably at least 2.5 Mol base per liter of solvent or at least 3 Mol per liter of solvent is added to obtain the solvent-base mixture. In one embodiment, even at least 4 Mol of base per liter of solvent is added. An additional amount of base may be added to the composition. Thus, initially at least 1 Mol base per liter of solvent or at least 1.5 Mol base per liter of solvent is combined with the base. Subsequently, an additional amount of base is added to the composition or during forming of the solution.

In instant process, the solvent-base mixture is in chemical equilibrium prior to combining with the aramid material. Thus, the solvent-base-mixture is in chemical equilibrium prior to addition of the aramid material to the solvent-base-mixture. Due to addition of a large amount of base, usually an excess of base, chemical equilibrium is reached. In chemical equilibrium, the reaction quotient (the quotient of the amount of reaction products and reactants) is constant over time at a specific temperature and pressure and equal to the equilibrium constant. Thus, the base has dissolved in the solvent (for example to saturation) and the concentration of the base dissolved in the solvent does basically not change over time at a given temperature. In particular, the concentration of cations originating from the base (K+ when KOH is used as base), anions originating from the solvent (dimsyl- when DMSO is used as solvent), the base (e.g. KOH) and the solvent (e.g. DMSO) preferably remain constant at a certain temperature and pressure. Depending on the amount of base added to the solvent, a solid, undissolved excess of base may be present in the solvent-base mixture and/or the composition and/or the solution. The base and the solvent may be mixed by stirring. Preferably, when DMSO is used as solvent, the aramid material is added only after dimsyl ions have formed.

In one embodiment, the solvent and/or the composition and/or the suspension comprise at most 10 wt % of a proton donor, preferably at most 5 wt %, even more preferably at most 2 wt % or even at most 1 wt % of a proton donor with respect to the weight of the solvent and/or with respect to solvent-base mixture and/or with respect to the composition and/or with respect to the solution. More preferably, the proton donor content is at most 0.5 wt % or even at most 0.2 wt %. A proton donor is e.g. water or an alcohol, such as e.g. ethanol, or an acid.

The low proton donor or water content may be achieved by working with analytical grade or nitrogen flushed solvents and by working under N₂ atmosphere.

In one embodiment, the composition is subjected to shearing, preferably strong shearing, to improve the disintegration and subsequent dissolution of the aramid material. This may improve the dissolution of the aramid material. Shearing may be applied by rigorous stirring, kneading or sonicating the composition. Sonication may be used at a frequency in the range of 10 to 50 kHz, preferably 15 to 25 kHz.

The dissolution of the aramid material preferably takes place at room temperature or slightly higher temperature, but below 50° C., preferably below 40° C., more preferably below 35° C., to avoid (hydrolytic) degradation of the polymer. Preferably, the dissolution of the aramid material takes place at a temperature of at least 15° C., preferably at least 18° C.

In one embodiment, at least step iii) of the process (the mixing of the composition) takes place in a mixer, in particular a high-shear mixer, e.g. a twin screw kneader, a twin screw extruder, a twin shaft kneader or mixer, a single screw kneader or single screw extruder or a Drais mixer. Preferably, step ii) and step iii) take place in a high-shear mixer, e.g. a twin screw kneader, a twin screw extruder, a twin shaft kneader or mixer, a single screw kneader or single screw extruder or a Drais mixer.

In particular for large-scale processes, it has been found that the use of such equipment is advantageous to create sufficient shear, use shorter mixing time and to enable a continuous process.

For a large-scale process, the following embodiment of the process may be used. Solvent and the indicated amount of base are stirred at room temperature in a vessel at (high) shear to reach chemical equilibrium. The solvent-base mixture is injected into a mixer, e.g. a twin screw extruder. The twin screw extruder may have separate inlets for the liquid solvent-base mixture and the solid aramid material. The liquid solvent-base mixture may be injected under high pressure and combined with the solid aramid material. Preferably, the solid aramid material is dosed into the extruder prior to the addition of the liquid solvent-base mixture. Optionally, an additional amount of base, either in solid form or an aqueous solution thereof, is added to the extruder. Such additional amount of base may e.g. be added downstream of where the solvent-base mixture is added to the extruder. The amount of aramid material and solvent-base mixture should be adjusted to result in a final polymer concentration of at least 5 wt %, preferably 7-22 wt %, more preferably 10-20 wt %, even more preferably 12-18 wt %. The processing in the (twin screw) extruder should take place at a temperature of at most 50° C., preferably at most 25° C. (if necessary, cooling will be applied). By adjusting the feeding dosage and the outlet stream (the extrudate), the mixing time is adjusted. To achieve high shear, rotation speeds of up to e.g. 300 rpm may be used. The screw configuration of the extruder can be constructed with a number of different elements such as transporting, mixing, and kneading elements. The following screw configuration may preferably be used: the entering zone element has preferably a length of 3-6 D (D stands for diameter of the screw in mm) and can have a length as large as 6 to 9 D and is equipped with transport elements which are single or double flighted. The single and double flighted elements are well known conveying elements which do not cause compaction during conveying. The mixing and dissolution zones may have a length of 15 to 30 D, and preferably of 20-23 D, using elements without transport character (screw elements such as W&P Igel or Hedgehog and/or single/multi row tooth mixing ZME; Berstorff single or multi row tooth mixing ZB, and Clextral multi row tooth mixing BMEL) or having interrupted transport character (screw elements such as W&P type SME or Berstorff type EAZ-ME). The mixing elements without transport character are characterized in that they do not cause conveying and that they are therefore totally filled-up with product, having dispersive mixing character. The mixing elements with interrupted transporting character have a channel with conveying character. These elements have distributive mixing character and are not necessary totally filled-up. Alternatively, the following screw configuration may be used: the entering zone element has a length of 2-10 D preferably 5-7 D (D stands for diameter of the screw in mm). The mixing and dissolution zones may have a length of 10 to 20 D, and preferably of 13-16 D, using elements with transport character. The degassing zone may have a length of 3-8 D and preferably 2-4 D using negative transport elements as vacuum loc and positive transport elements at the vacuum connection of the (twin screw) extruder. The mixing and compression zones may have a length of 10 to 30 D, and preferably of 16-19 D, using elements with transport or compression character.

Optionally, a vacuum (underpressure) can be applied in the extruder, to remove any gases and to obtain a gas-free aramid solution suitable for further processing. Preferably, the extrudate is collected in closed vessels or barrels (to exclude the presence of proton donors, e.g. humid air).

Optionally, large undissolved base particles, e.g. particles having a size of more than 0.5 μm, are removed from the solvent-base mixture prior to combining the aramid material with the solvent-base mixture. In the larger scale process, the removal of large undissolved base particles may be carried out prior to injection of the solvent-base mixture into the mixing device (e.g. by sedimentation, decantation or filtration).

Optionally, undissolved aramid material is removed from the solution of aramid, e.g. by sedimentation, decantation or filtration.

For instant process, the concentration or amount of aramid material in the composition may be at least 1 wt %, preferably at least 2 wt %, more preferably at least 4 wt %, even more preferably at least 4.5 wt % with respect to the weight of the composition. The concentration of aramid material in the composition may also be in the range of up to 25 wt %. Preferably, the concentration of aramid material in the composition is at least 10 wt %.

Preferably, the concentration of aramid in the solution, thus dissolved, is in the same range.

In one embodiment, the aramid material is combined with the solvent-base mixture by combining the aramid material with the solvent-base-mixture in at least two steps, preferably at least three steps, more preferably at least four steps. Preferably, the amount of aramid material added in one step is in the range of 0.1 to 2 wt % with respect to the weight of the solution.

For example, an amount of aramid material in the range of 0.5 wt % to 1 wt % relative to the weight of the solution may be added per step. Between the steps, stirring or sonication may be applied. The amount of aramid material added per step may be evenly distributed over the number of steps (e.g. 1/3 in each of three steps) or the amount may vary between steps (e.g. either increasing or decreasing between steps).

In one embodiment, in total at least 2 Mol of base per liter of solvent are added to prepare the solvent-base mixture and at least 2.5 wt % of aramid material are combined with the solvent-base mixture to result in the solution, preferably at least 2.5 Mol of base per liter of solvent and at least 4 wt % of aramid material.

An advantage of the instant process is the short time to obtain an aramid solution. The first process step, i.e. combining base and solvent to result in a solvent-base mixture in chemical equilibrium preferably takes 2 to 24 hours, depending on the choice of mixing device. By using a base with a small particle size, the time may be reduced. The third process step, i.e. mixing the composition to obtain a solution of aramid preferably takes 5 minutes to 2 hours, depending on the choice of the mixing device.

Another object of this application is a solution comprising a solvent, a base and aramid, wherein the solution comprises at least 1 Mol base per liter of solvent, preferably at least 1.5 Mol, more preferably at least 2 Mol, even more preferably at least 3 Mol base per liter of solvent.

In one embodiment, an object of this application is a solution comprising a solvent, a base and aramid, wherein the solution is saturated with regard to the amount of base. Thus, no more base will dissolve in the solution at a certain temperature and pressure.

This solution may be obtained by initially adding an excess of base to the solvent, to create the solvent-base mixture, by removing the solid excess of base (e.g. by decantation or filtration of the solvent-base mixture) and by adding an amount of aramid.

Due to using instant process, the instant solution of aramid (or aramid solution) is a non-fibrous solution wherein the amide bonds within the aramid polymer chain are largely, and preferably fully, deprotonated. Aramid polymer in crystal form (undissolved) still includes protons in hydrogen bonds. The protonation status of the aramid may be determined by NMR (Nuclear magnetic resonance spectroscopy), in particular H¹-NMR.

The forming of a red solution indicates the dissolution and at least partly deprotonation of the aramid polymer.

To determine and prove (complete) deprotonation of aramid by the solvent with base, solutions of the aramid in the deuterated solvent with base are made and presence of the amide proton in the 1H NMR spectrum is determined. In the case of poly(para-phenylene terephthalamide) (PPTA) and DMSO, a solution of PPTA in DMSO-d6/KOH is made and stirred at room temperature.

After dissolution, standard 1H spectra of the samples were recorded on a Bruker Avance III 400 MHz NMR. Quantification was performed using the so-called eretic procedure where from a separately measured solution of DMSO-d6/KOH with 10 mg DMSO an internal standard is projected on an empty region of the sample spectra. Since DMSO-d6 does not contain exchangeable deuterons an amide proton would normally be expected between 9-11 ppm in the 1H NMR spectrum. The absence of such signal in the spectra recorded for in DMSO-d6/KOH indicates complete deprotonation of the amide group. Thus, the PPTA is completely deprotonated in a DMSO/KOH solution as proven by the (almost) absence of the amide proton (i.e. maximum of 2 mol %) in the 1H NMR spectrum. Hence, preferably the aramid solution of instant invention comprises at most 5 mol %, even more preferably at most 2 mol % of protonated amide groups determined as described above. In addition, 13C {1H} NMR spectra may be recorded to observe and estimate the end group contents. Estimations made from a 2% (m/m) PPTA in DMSO-d6/KOH solution result in end group contents in the expected range. Therefore, it can be concluded that no degradation of the polymer in the DMSO/KOH solution occurred.

The prior art processes which prepare aramid nanofiber dispersions or a dispersion of aramid polymer in an amide solvent (e.g. NMP) with a co-solvent (e.g. CaCl₂) or the solutions of aramid in sulfuric acid are different from the solution of instant invention. They are dispersions of aramid nanofibers or dispersions of aramid polymer wherein the amide bonds are not fully deprotonated. In instant solution, the amide bonds are preferably fully deprotonated.

In a solution of aramid in sulfuric acid, the amide groups in the polymer are protonated. In a solution of NMP with a co-solvent, the ions of the co-solvent (e.g. Ca²⁺) are bound to the amide groups. Where ANF dispersions are produced with a proton donor, the amide groups are at least partially protonated.

In one embodiment, the solution comprises at least 1 wt %, preferably at least 2 wt %, more preferably at least 4 wt %, even more preferably at least 4.5 wt % of aramid with respect to the weight of the solution. The concentration of aramid in the solution may also be in the range of up to 25 wt %. Preferably, the concentration of aramid material in the composition is at least 10 wt %.

The concentration of the solution may be chosen dependent on the further processing. For spinning of the solution into fibers, higher concentrations are preferred (for example 5 to 25 wt %), while for the making of resin composites, lower concentrations may be used (for example up to 5 wt %).

Preferably, the aramid solution shows optical anisotropy (liquid crystalline behavior), i.e. the aramid molecules are closely packed and adapt an ordered arrangement.

The optical anisotropy of the solution may be examined under a polarization microscope (bright image) and/or seen as opalescence during stirring.

Usually, aramid solutions comprising at least 3 wt % of aramid (at room temperature) will show optical anisotropy. Aramid solutions with higher concentrations (e.g. at least 4 wt %, at least 5 wt % or at least 10 wt %) will show optical anisotropy.

Optical anisotropy may also be referred to as birefringence.

The present invention also pertains to processes to process the solution into various shaped products or materials, such as continuous aramid fiber, aramid nanofiber, an aramid film or composites comprising aramid.

Thus, present invention pertains to a process to manufacture a continuous aramid fiber, comprising:
i) providing the solution as described above or the solution produced according to any of the embodiments of the process,
ii) passing the solution through a spinneret,
iii) coagulating the solution to result in a fiber, and
iv) washing the fiber.

Preferably, the process to manufacture a continuous aramid fiber spinning process is a dry-jet wet spinning process. This means, that the solution is passed through a gaseous medium after exiting the spinneret and before entering the coagulation bath. Preferably, the solution passes through a gaseous medium. The gaseous non-coagulating medium preferably consists of air.

The gaseous medium (also referred to as air gap) preferably has a length in the range of 2 to 20 mm, more preferably 3 to 15 mm and even more preferably of 5 to 10 mm.

In the gaseous medium through which the solution passes, the aramid present in the solution is drawn. However, it is also possible to process the solution into continuous fibers in a wet spinning process without using an airgap and thus after leaving the spinneret, the solution directly passes into the coagulation bath.

The degree of drawing, that is the ratio between the length of the filaments upon leaving the coagulation bath and the average length of the solution upon leaving the spinning orifices of the spinneret, may be in the range of 1.5 to 15, preferably 2 to 6.

After coagulation, the continuous aramid fibers formed are removed from the coagulation bath, washed, dried and taken up on a bobbin. The spinnerets that are used may be of a type known in itself for dry jet-wet spinning.

Surprisingly, it has been found that spinning of the aramid solution, in particular spinning into low titer filaments, and subsequent washing of the filaments, allows the efficient removal of the base.

If para-aramid polymer that has not been processed or shaped previously is used as starting material (aramid material) to make the solution, the continuous para-aramid fiber obtained by this process is free of sulfonic acid groups.

Alternatively, if the aramid material comprises recycled aramid, the continuous para-aramid fiber obtained by this process will have sulfonic acid groups.

Continuous aramid fibers produced in this way may have attractive mechanical properties, e.g. they may show less fibrillation (higher abrasion resistance), have a high elongation at break and/or a high resistance to transverse compression.

The continuous aramid fibers produced by the process may preferably have an elongation at break of at least 5%, more preferably of at least 7.5%, even more preferably of at least 10%. The elongation at break can even be higher than 15%. The elongation at break is determined according to ASTM D7269 after conditioning at 20° C. and 65% relative humidity for 14 hours in accordance with ASTM D1776.

Hence, an object of this invention is also a continuous aramid fiber having an elongation at break of at least 5%, more preferably at least 7.5%, even more preferably of at least 10% or at least 15%, determined as described above.

Another object of present invention is a process to manufacture aramid nanofiber, comprising:
i) providing the solution or the solution produced according to any of the embodiments of the process, and
ii) adding an amount of a proton donor to the solution.

The proton donor may e.g. be selected from water and alcohol (e.g. ethanol or methanol).

The aramid nanofiber obtained by this process may be used for coating various substrates, in particular to amend or improve the substrate properties or at least the surface properties of the substrate. For example, a coating of aramid nanofibers may be used to improve the fire resistance of a substrate.

Further, the aramid nanofiber may be used for the reinforcement of composite materials, in particular aramid nanofiber may be added to the resin or matrix material of the composite.

Alternatively, the aramid nanofiber may be used as filler material (e.g. in sheet-like materials such as papers or in composites) or as adhesive.

Another object of present invention is a process to manufacture an aramid film, comprising:
i) providing the solution as described above or the solution produced according to any of the embodiments of the process,
ii) supplying the solution on a surface, and
iii) solidifying the solution to form a film.

In one embodiment, the solution may be combined with a solution of another polymer prior to supplying the solution on a surface. The combined solution may be used to manufacture an aramid film comprising another polymer.

The surface may be a support surface. Alternatively, the surface is part of an object which is to be coated with a film of the solution.

The solution may be supplied to the (support) surface by casting, e.g. from a die, or application with a roller.

Alternatively, an object which is to be coated with a film of the solution is dipped into the solution or coated by other methods, including spraying or other well-known methods.

Subsequently, the solution is solidified to form a film. This may be realized by drying or by coagulation. For coagulation, the solution is subjected to an aqueous coagulant, e.g. water or an aqueous solution of the solvent.

Preferably, the film is rinsed or washed to remove residual solvent and/or base. The washed film may be subjected to drawing and drying. Optionally, the dried film may be heat-treated.

The solution may also be used to manufacture a resin composite. The solution may be combined with a resin or added to a resin solution (e.g. comprising epoxy resin) to improve the mechanical properties of the resin after it has been hardened.

Hence, this application also pertains to the aramid nanofiber, the aramid film and the continuous aramid fiber obtained by any of the processes for processing the aramid solution. Further, the application pertains to materials comprising the aramid nanofiber obtained by the above described process. The material may be selected from a coating and a composite.

The invention is further illustrated by the following, non-limiting examples.

### EXAMPLE 1

A solution was formed by dissolving 5.61 g KOH in 50 mL DMSO (2 M base in solvent) in a sealed 250 mL Erlenmeyer closed with a glass stop and parafilm after adding a nitrogen flow. The solvent was stirred for 24 hours. The solvent (50 mL) was decanted and added into a 1 L glass reactor where 1,68 g p-phenylene terephthalamide (PPTA, Twaron® 1000 shortcut, 6 mm length) was added and stirred for approximately 1.5 hours (corresponding to an aramid concentration of 3 wt %). The dissolution was completed when no visible PPTA fibers were detected by the Leica light microscope with crossed polarized lights.

A film was made from the solution. A portion of the solution (one lab spoon) was spread out over a glass plate by a doctor blade. The glass plate was added in a demi water bath until the film was fully coagulated. The film was added in an alcohol bath in order to wash out the water. Finally the film was dried on a glass plate in the fume hood.

### EXAMPLE 2

Solutions were formed by dissolving 2,80 g KOH in 50 mL DMSO (1 M base in solvent) in a sealed 250 mL Erlenmeyer closed with a glass stop and parafilm after adding a nitrogen flow. The solvent was stirred for 24 hours. The solvent (50 mL) was decanted and added into a 1 L glass reactor where 1,68 g PPTA (Twaron® 1000 shortcut, 6 mm length) was added and stirred for approximately 3 hours (corresponding to an aramid concentration of 3 wt %). The dissolution was completed when no visible PPTA fibers were detected by the Leica light microscope with crossed polarized light.

A film was made from the solution. A portion of the solution (one lab spoon) was spread out over a glass plate by a doctor blade. The glass plate was added in a demi water bath until the film was fully coagulated. The film was added in an alcohol bath in order to wash out the water. Finally the film was dried on a glass plate in the fume hood.

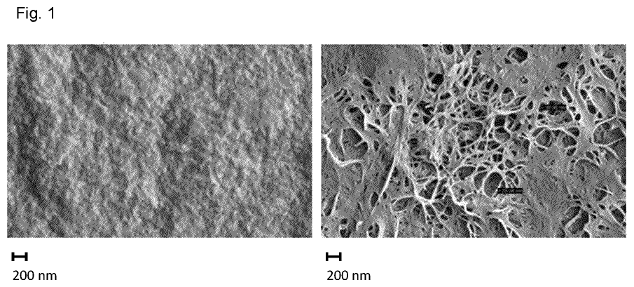

The films of example 1 and 2 were analyzed by Scanning Electron Microscopy (SEM). The SEM images are shown in FIG. 1 (right image: example 2, left image: example 1).

1. A process to manufacture a solution of aramid comprising:
i) combining a solvent and a base to result in a solvent-base mixture,
ii) combining aramid material with the solvent-base mixture to obtain a composition, and
iii) mixing the composition to obtain a solution of aramid,
wherein at least 1 Mol of base per liter of solvent is added to obtain the solvent-base mixture.

2. The process according to claim 1 wherein the solvent-base mixture is in chemical equilibrium prior to combining with the aramid material.

3. The process according to claim 1 wherein at least 1.5 Mol of base per liter of solvent is added.

4. The process according to claim 1 wherein the solvent and/or the solvent-base-mixture and/or the composition and/or the solution comprise at most 10 wt % of a proton donor with respect to the weight of the solvent and/or with respect to the weight solvent-base mixture and/or with respect to the weight of the composition and/or with respect to the weight of the solution.

5. The process according to claim 1 wherein the composition is subjected to shearing.

6. The process according to claim 1 wherein at least step iii) takes place in a twin screw kneader or a twin screw extruder.

7. The process according to claim 1 wherein the amount of aramid material is at least 1 wt % with respect to the weight of the composition.

8. A solution comprising a solvent, a base and aramid, wherein the solution comprises at least 1 Mol base per liter of solvent.

9. The solution of claim 8, wherein the solution comprises at least 1 wt % aramid with respect to the weight of the solution.

10. The solution of claim 8 showing anisotropic liquid crystalline behavior.

11. The solution of claim 8 wherein the aramid comprises at most 5 mol % of protonated amide groups, as determined by nuclear magnetic resonance spectroscopy.

12. A process to manufacture a continuous aramid fiber, comprising:
i) providing a solution comprising a solvent, a base and aramid, wherein the solution comprises at least 1 Mol base per liter of solvent, or the solution produced according to the process of claim 1.
ii) passing the solution through a spinneret,
iii) coagulating the solution to result in a fiber, and
iv) washing the fiber.

13. A continuous aramid fiber having an elongation at break of at least 5%, determined according to ASTM D7269.

14. A process to manufacture aramid nanofiber, comprising:
i) providing a solution comprising a solvent, a base and aramid, wherein the solution comprises at least 1 Mol base per liter of solvent, or the solution produced according to the process of claim 1, and
ii) adding an amount of a proton donor to the solution.

15. A material comprising the aramid nanofiber obtained by the process of claim 14, being selected from a coating and a composite.

16. A process to manufacture an aramid film, comprising:
i) providing a solution comprising a solvent, a base and aramid, wherein the solution comprises at least 1 Mol base per liter of solvent, or the solution produced according to the process of claim 1,
ii) supplying the solution on a surface, and
iii) solidifying the solution to form a film.
